(19) United States
(12) Patent Application Publication
(10) Pub. No.: US 2011/0169964 A1
(43) Pub. Date: Jul. 14, 2011

(54) Quality index value calculation method, information processing apparatus, video delivery system, and non-transitory computer readable storage medium

(75) Inventor: Makiko Konoshima, Kawasaki (JP)

(73) Assignee: Fujitsu Limited, Kawasaki (JP)

(21) Appl. No.: 13/064,363

(22) Filed: Mar. 21, 2011

Related U.S. Application Data
(63) Continuation of application No. PCT/JP2008/067130, filed on Sep. 22, 2008.

(51) Int. Cl. H04N 17/00

(52) U.S. Cl. 348/180; 348/E17.001

(57) ABSTRACT

A quality index value S′, such as a degree of block distortion or edge sharpness, of each frame constituting video data, an error region ratio Q as a ratio of an error region in which a packet error or the like occurs, and a pixel difference level N as a level of difference from color originally used in the video data are calculated, and a quality index value S is calculated based on the calculated quality index value S′, the error region ratio Q, and the video delivery system 2. Accordingly, it is possible to calculate the quality index value indicating quality of video data that is approximately the same as quality determined by a person.

### CROSS-REFERENCE TO RELATED APPLICATION

This application is a continuation of International Application No. PCT/JP2008/067130, filed on Sep. 22, 2008, the entire contents of which are incorporated herein by reference.

### FIELD

The embodiments discussed herein are directed to a quality-index-value calculation method, an information processing apparatus, a video delivery system, and a non-transitory computer readable storage medium.

### BACKGROUND

Video delivery systems for delivering video data to user terminals are being increasingly used. A delivery server for delivering video data encodes the video data to generate bit stream data. The delivery server then transmits the generated bit stream data to a user terminal via a network. The user terminal decodes the received bit stream data to reproduce the video data.

In such a video delivery system, because the delivery server performs compression coding on the video data by using a technology such as inter-frame prediction, the user terminal sometimes may not completely reproduce the video data. In this case, a quality of the video data decoded by the user terminal degrades. In recent years, to evaluate the degree of degradation of video data held by a user terminal, an index value indicating the quality of video data (hereinafter, referred to as a “quality index value”) may be calculated.

A NR (Non Reference) method and a RR (Reduced Reference) method are known methods for calculating the quality index value of video data. The NR method is a method for calculating, as the quality index value, the degree of block distortion (shift at a block boundary) or the degree of blurring (a cumulative value of edges detected by using a Sobel filter or the like) of video data decoded by the user terminal (hereinafter, referred to as a “received video image”). The RR method is a method of calculating the quality index value by comparing feature data of video data held by the delivery server (hereinafter, referred to as a “transmitted video image”) with the received video image held by the user terminal.

Patent Literature 1: Japanese National Publication of International Patent Application No. 2002-528008

Patent Literature 2: Japanese Laid-open Patent Publication No. 2006-033722

Patent Literature 3: Japanese Laid-open Patent Publication No. 2001-275136

In the video delivery system, packet loss or a bit error may occur during the transfer of bit stream data. In this case, the video data decoded by the user terminal is locally degraded. When a person views the locally-degraded video data, he/she perceives that the quality (image quality or the like) is significantly lowered. However, the video data quality evaluation method described above has a problem in that even if the video data is locally degraded, a quality index value calculated by the method indicates quality that is different from quality that a person visually perceives. This is because the quality index value calculated by the NR method indicates only objective quality based on the degree of block distortion or the degree of blurring.

This problem will be described in detail below with reference to FIG. 11. A frame F10 illustrated in FIG. 11 is a predetermined frame constituting a transmitted video image. Frames F11 and F12 illustrated in FIG. 11 are frames that a user terminal obtains by decoding the frame F10 that has been encoded by a delivery server. In the example illustrated in FIG. 11, the overall quality of the frame F11 is degraded because it is difficult for the user terminal to completely decode the frame F10. Specifically, in the frame F11, block distortion is increased or edges are more blurred than the frame F10. Further, the overall quality of the frame F12 is degraded and a region F12a is locally degraded due to packet loss or the like.

When the quality index values for the frames F11 and F12 are calculated by the NR method, the quality index value of the frame F11 and the quality index value of the frame F12 sometimes becomes substantially identical to each other. However, the quality of the frame F12 that a person visually perceives is significantly worse than the quality of the frame F11. In this manner, the quality index value calculated by the conventional NR method sometimes indicates the quality that is different from the quality that a person visually perceives when the video data is locally degraded due to packet loss or the like.

The above-mentioned problem also occurs in the RR method. In the RR method, because the feature data of a transmitted video image is used, it is possible to calculate a quality index value with higher accuracy than the NR method. However, when the video data is significantly degraded, the above problem occurs.

A FR (Full Reference) method is also known as the method for calculating the quality index value of video data. However, in the FR method, pixels of a transmitted video image and a received video image are compared with each other. Therefore, when a delivery server and a user terminal are physically separated from each other, it is difficult to use the FR method.

### SUMMARY

According to an aspect of an embodiment of the invention, a quality-index-value calculation method implemented by an information processing apparatus that calculates quality of video data, the quality-index-value calculation method includes receiving video data that is divided into packets; decoding the video data for each frame when the packets are received at the receiving; detecting whether any packet is lost based on the packets received at the receiving, and detecting whether a bit error occurs in the packets received at the receiving; identifying, as an error region, a region corresponding to a packet that is detected as being lost at the detecting and a region in which the bit error is detected at the detecting from an entire region of each frame decoded at the decoding; calculating a ratio of the error region identified at the identifying to the entire region of each frame, as a quality index value indicating the quality of the frame; and calculating a pixel difference between an average of pixel values in the error region identified at the identifying and a predetermined threshold for each frame.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a diagram illustrating a video delivery system including an information processing apparatus according to a first embodiment;

FIG. 2A is a diagram for explaining a process for calculating a quality index value of an I frame;

FIG. 2B is a diagram for explaining a process for calculating a quality index value of a P frame or a B frame;

FIG. 3 is a diagram of a configuration of the information processing apparatus according to the first embodiment;

FIG. 4 is a flowchart illustrating a procedure of a quality-index-value calculation process performed by the information processing apparatus according to the first embodiment;

FIG. 5 is a diagram illustrating a video delivery system according to a second embodiment;

FIG. 6 is a diagram of a configuration of an information processing apparatus illustrated in FIG. 5;

FIG. 7 is a diagram of a configuration of a quality management apparatus illustrated in FIG. 5;

FIG. 8 is a flowchart illustrating a procedure of a quality determination process performed by the quality management apparatus illustrated in FIG. 5;

FIG. 9 is a diagram illustrating a computer that executes a quality-index-value calculation program;

FIG. 10 is a diagram illustrating a computer that executes a quality determination program; and

FIG. 11 is diagram for explaining a conventional technology.

### DESCRIPTION OF EMBODIMENTS

Preferred embodiments of the present invention will be explained with reference to accompanying drawings. The quality-index-value calculation method, the information processing apparatus, the video delivery system, and the non-transitory computer readable storage medium according to the present invention are not limited by the following embodiments.

### [a] First Embodiment

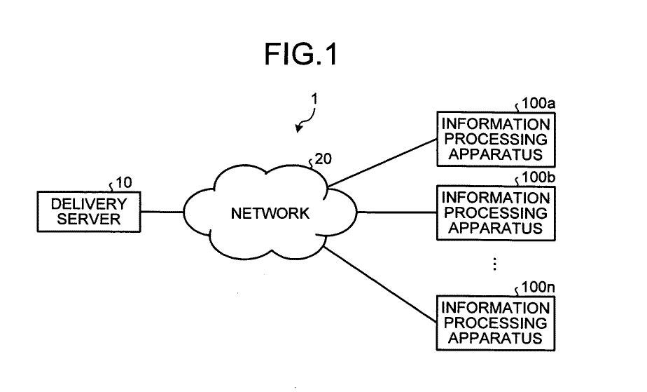

First, a video delivery system 1 including an information processing apparatus 100 according to a first embodiment will be explained. FIG. 1 is a diagram illustrating the video delivery system 1 including the information processing apparatus 100 according to the first embodiment. As illustrated in FIG. 1, the video delivery system 1 includes a delivery server 10 that delivers video data and information processing apparatuses 100a to 100n that receive the video data via a network 20. In the following description, the information processing apparatuses 100a to 100n are collectively referred to as the information processing apparatus 100 when they need not be identified.

The delivery server 10 stores therein video data, and delivers the video data to the information processing apparatus 100 via the network 20. Specifically, the delivery server 10 performs coding on the video data to generate bit stream data, divides the generated bit stream data into packets with a predetermined size, and transmits the packets to the network 20.

The information processing apparatus 100 receives the bit stream data delivered by the delivery server 10, and performs control to display the received bit stream data on a predetermined display unit. Specifically, the information processing apparatus 100 decodes the bit stream data received from the delivery server 10, and stores the decoded video data in a predetermined memory unit or performs display control on a predetermined display unit.

In the video delivery system 1, the quality of the video data (received video image) decoded by the information processing apparatus 100 may be lower than the quality of the video data (transmitted video image) stored in the delivery server 10. Specifically, in the received video image, block distortion may be increased, edges may be blurred, or a part of the image may be lost. One reason for the degradation of the quality of the received video image is that it is difficult for the delivery server 10 to completely reproduce the transmitted video image because the delivery server 10 performs compression coding on the video data by inter-frame prediction or intra prediction. Another reason for the degradation of the quality of the received video image is that packet loss may occur during transfer of the bit stream data or a bit error may occur on the bit stream data.

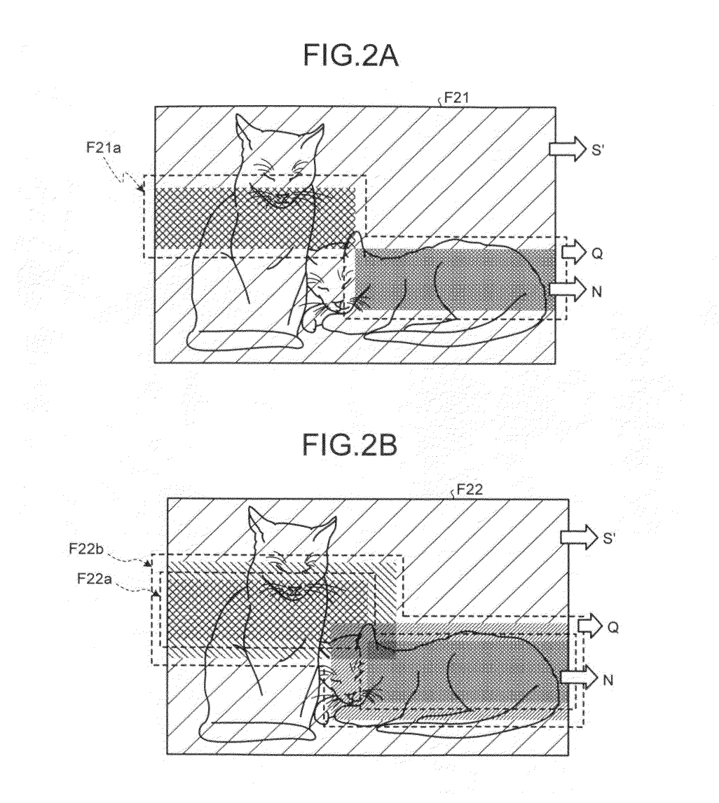

The information processing apparatus 100 according to the first embodiment calculates a quality index value indicating the quality of the received video image for each frame. Specifically, the information processing apparatus 100 calculates not only an objective quality index value but also a quality index value indicating the quality that is approximately the same as the quality that a person visually perceives. A quality-index-value calculation process performed by the information processing apparatus 100 will be explained in detail below with reference to FIG. 2A and FIG. 2B. In the following, explanation is separately given of a process for calculating a quality index value of an I frame (Intra coded Frame) that is coded without using inter-frame prediction and of a process for calculating a quality index value of a P frame (Predicted Frame) or a B frame (Bi directional Predicted Frame) that is coded by using inter-frame prediction.

FIG. 2A is a diagram for explaining the process for calculating a quality index value of the I frame. In a frame F21 illustrated in FIG. 2A, the degree of block distortion is increased and edges are blurred, so that the overall image quality is degraded. In the frame F21, a region F21a of the frame F21 is locally degraded due to packet loss or the like.

When calculating a quality index value S of the frame F21, the information processing apparatus 100 firstly calculates a quality index value S′ of the frame F21 in the same manner as the conventional NR method. Specifically, the information processing apparatus 100 calculates the degree of block distortion or a cumulative value of edges of the frame F21 as the quality index value S′. The lower value of the calculated quality index value S′ indicates higher quality, and the higher value indicates the lower quality.

The calculated quality index value S′ is an index value based on the degree of block distortion or the cumulative value of the edges, so that the quality index value S′ does not largely change regardless of whether a part of the image is locally degraded. However, the quality that a person visually perceives largely varies depending on whether a part of the image is locally degraded. For example, when the region F21a is locally degraded, a person perceives that the quality of the frame F21 is significantly degraded compared with an image in which the region F21a is not locally degraded.

The information processing apparatus 100 identifies a region that is locally degraded due to packet loss or the like, and corrects the quality index value S′ to calculate a quality index value S indicating the quality that is approximately the same as the quality that a person visually perceives. Specifically, the information processing apparatus 100 determines, in a process of decoding the frame F21, whether there is a lost packet among a plurality of packets constituting the frame F21 and whether there is a packet in which a bit error occurs.

The information processing apparatus 100 identifies a region corresponding to the lost packet and a region corresponding to the packet in which the bit error occurs as a region that is locally degraded. In the example illustrated in FIG. 2A, the information processing apparatus 100 identifies the region F21a as the region that is locally degraded. In the following, a region that is determined, by the information processing apparatus 100, to be locally degraded is referred to as an “error region”.

Subsequently, the information processing apparatus 100 calculates a ratio Q of the error region (hereinafter, referred to as an “error region ratio”) to the entire region of the frame F21. Specifically, the information processing apparatus 100 calculates the error region ratio Q by dividing the size of the error region by the size of the frame F21. The calculated error region ratio Q takes a value in the range of “0.0 to 1.0”, and a greater value indicates a lower quality.

For example, when the size of the frame F21 is “300” and the size of the error region is “60”, the information processing apparatus 100 calculates the error region ratio Q such that 60/300=0.2. For example, when the size of the frame F21 is “300” and the size of the error region is “120”, the information processing apparatus 100 calculates the error region ratio Q such that 120/300=0.4.

The information processing apparatus 100 also calculates a difference level (hereinafter, referred to as a “pixel difference level”) between color that is used in the error region and color that is originally used in the frame F21. In the description, color information used in an image is represented by a Y (luminance signal) component, a U (color-difference signal) component, and a V (color-difference signal) component. Each of the Y component, the U component, and the V component takes an 8-bit value (0 to 255).

The reason for calculating the pixel difference level will be explained below. For example, when the frame F21 is a natural image, it is known that the U component and the V component used in the frame F21 generally take values in the range of 70 to 130. This is because the U component and the V component out of the range of 70 to 130 represent artificial color or fluorescent color, which do not occur in nature. In this manner, it is sometimes the case that the most of color used in video data can be determined according to the type of the video data (a natural image, an animation, or the like). In this case, the quality is lowered as the difference between the color being used in the video data and the color that has originally been used increases.

The information processing apparatus 100 calculates how much the color used in the error region is different from the color originally used in the frame F21. Specifically, the information processing apparatus 100 calculates an average of the Y components, an average of the U components, and an average of the V components of respective pixels in the error region. The information processing apparatus 100 then calculates a pixel difference level N based on the calculated average of the Y components, the calculated average of the U components, the calculated average of the V components, and a predetermined threshold range (hereinafter, referred to as a “pixel feature threshold”). The calculated pixel difference level N takes a value in the range of “0.0 to 1.0”, and a greater value indicates lower quality. In the following, the average of the Y components, the average of the U components, and the average of the V components of the respective pixels in the error region may collectively be referred to as image feature C.

When the natural image is taken as an example for explanation, the image feature threshold corresponds to a color space with the Y components in the range of “0 to 255” and the U components and the V components in the range of “70 to 130”. The information processing apparatus 100 calculates the image feature C, and then calculates the shortest distance between the image feature threshold and the image feature C in the color space. The information processing apparatus 100 then calculates the image difference level N by dividing the calculated shortest distance by a predetermined representative value. The “representative value” means a value that is most different from the image feature threshold in the color space. For example, when the representative value is “100” and the shortest distance between the image feature threshold and the image feature C in the color space is “10”, the information processing apparatus 100 calculates the image difference level N such that 10/100=0.1.

Subsequently, the information processing apparatus 100 calculates the quality index value S based on the quality index value S′, the error region ratio Q, and the image difference level N. Specifically, the information processing apparatus 100 divides the quality index value S′ by a value obtained by subtracting the error region ratio Q from a value “1” and then dividing the quotient by a value obtained by subtracting the image difference level N from a value “1” to thereby obtain the quality index value S. That is, the information processing apparatus 100 calculates the quality index value S according to the following Equation.

S=S′/{(1−Q)×(1−N)} (1)

For example, when the quality index value S′ is “100”, the error region ratio Q is “0.2”, and the image difference level N is “0.1”, the information processing apparatus 100 calculates the quality index value S such that 100/{(1−0.2)×(1−0.1)}=139 according to Equation (1). For example, when the quality index value S′ is “100”, the error region ratio Q is “0.4”, and the image difference level N is “0.2”, the information processing apparatus 100 calculates the quality index value S such that 100/{(1−0.4)×(1−0.2)}=208 according to Equation (1). In this example, the calculated quality index value S is rounded off.

That is, the quality index value S calculated by the information processing apparatus 100 increases as the error region ratio Q increases, and thereby indicates lower quality. In general, a person determines that the quality of video data is lowered as the size of the error region increases. Because the information processing apparatus 100 corrects the quality index value S′ so as to indicate lower quality as the error region ratio Q increases when calculating the quality index value S, the information processing apparatus 100 can calculate the quality index value S indicating the quality of video data that is approximately the same as the quality determined by a person.

The quality index value S calculated by the information processing apparatus 100 increases as the image difference level N increases, and thereby indicates lower quality. In general, a person determines that the quality of video data is lowered as a difference between the color being used in the video data and the color that has originally been used in the video data increases. Because the information processing apparatus 100 corrects the quality index value S′ so as to indicate lower quality as the image difference level N increases when calculating the quality index value S, the information processing apparatus 100 can calculate the quality index value S indicating the quality of video data that is approximately the same as the quality determined by a person.

The process for calculating the quality index value of the P frame or the B frame will be described below. FIG. 2B is a diagram for explaining the process for calculating a quality index value of the P frame or the B frame. The frame that a frame F22 refers to is the frame F21 illustrated in FIG. 2A.

The overall quality of the frame F22 is degraded because of block distortion or edge blurring, and a region F22a of the frame F22 is locally degraded due to packet loss or the like. Because the frame F22 refers to the region F21a that is locally degraded in the frame F21, the quality degradation is propagated to a region F22b.

When calculating the quality index value S of the frame F22 as described above, the information processing apparatus 100 calculates the quality index value S′ of the frame F22 in the same manner as the conventional NR method. Specifically, the information processing apparatus 100 calculates, as the quality index value S′, the degree of block distortion or a cumulative value of edges of the frame F22 in the same manner as the example described with reference to FIG. 2A.

Subsequently, the information processing apparatus 100 identifies a region that is locally degraded due to packet loss or the like. Specifically, the information processing apparatus 100 identifies, as the error region, a region corresponding to a lost packet and a region corresponding to a packet in which a bit error occurs in the frame F22, in the same manner as the example described with reference to FIG. 2A. In the example illustrated in FIG. 2B, the information processing apparatus 100 identifies the region F22a as the error region.

Subsequently, the information processing apparatus 100 calculates the image difference level N in the error region. Specifically, the information processing apparatus 100 calculates the image difference level N based on the image feature C and the image feature threshold in the error region in the same manner as the example described with reference to FIG. 2A.

The information processing apparatus 100 estimates a region, to which the quality degradation is propagated, based on motion vector information. Specifically, the information processing apparatus 100 estimates, as the region to which the quality degradation is propagated, a region that refers to the error region F21a of the frame F21 as a reference source and in which the average of Y components, the average of U components, and the average of V components are close to the image feature C calculated in the above-described manner. In the example illustrated in FIG. 2B, the information processing apparatus 100 estimates that the region F22b is the region to which the quality degradation is propagated. In the following, the region that is estimated, by the information processing apparatus 100, as the region in which the quality degradation is propagated is referred to as an “error diffusion region”.

Subsequently, the information processing apparatus 100 calculates a ratio (error region ratio Q) of a sum of the error region and the error diffusion region to the entire region of the frame F22. Specifically, the information processing apparatus 100 calculates the error region ratio Q by dividing the sum of the size of the error region and the size of the error diffusion region by the size of the frame F22.

Subsequently, the information processing apparatus 100 calculates the quality index value S based on the quality index value S′, the error region ratio Q, and the image difference level N. Specifically, the information processing apparatus 100 calculates the quality index value S according to Equation (1) in the same manner as the example described with reference to FIG. 2A.

The information processing apparatus 100 performs the above-mentioned quality-index-value calculation process for each frame. The information processing apparatus 100 accumulates the calculated quality index value S in a predetermined storage unit or perform display control on a predetermined display unit. The information processing apparatus 100 may calculate the average of quality index values of all of the frames constituting one video data and perform control to display the calculated average as the quality index value of the video data on a predetermined display unit.

As described above, the information processing apparatus 100 according to the first embodiment calculates the quality index value S′ indicating objective quality by taking into account the degree of block distortion or the edge sharpness, and then corrects the quality index value S′ based on the error region ratio Q to calculate the quality index value S. Specifically, the information processing apparatus 100 calculates the quality index value S that indicates lower quality as the error region ratio Q increases. That is, the information processing apparatus 100 can calculate the quality index value S that indicates lower quality as the size of the error region increases, in the similar manner that a person perceives lower quality of video data as the size of the error region increases.

Furthermore, the information processing apparatus 100 calculates the quality index value S by correcting the quality index value S′ based on the image difference level N. Specifically, the information processing apparatus 100 calculates the quality index value S that indicates lower quality as the image difference level N increases. That is, the information processing apparatus 100 can calculate the quality index value S that indicates lower quality as the image difference level N increases, in the similar manner that a person perceives lower quality of video data as the size of the error region increases.

Because the information processing apparatus 100 calculates the error region ratio Q by estimating the error diffusion region, it is possible to calculate the quality index value S of the P frame or the B frame by taking into account the propagation of the quality degradation.

As described above, the information processing apparatus 100 can calculate the quality index value S indicating the quality of video data that is approximately the same as the quality determined by a person.

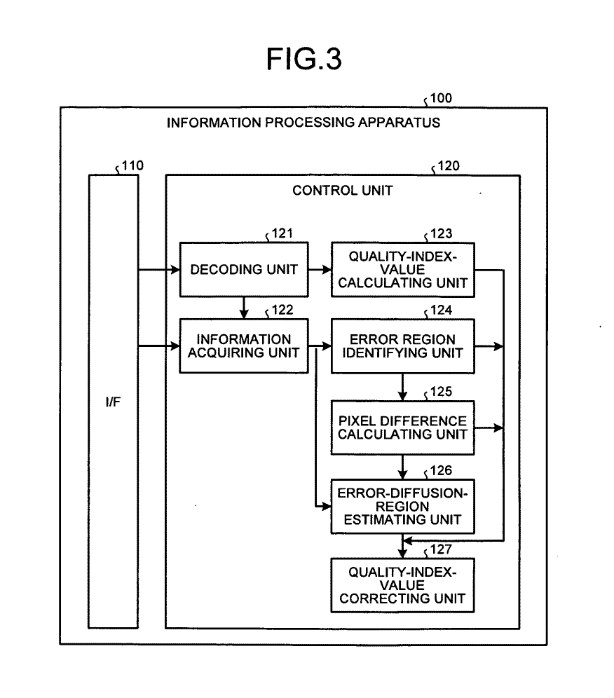

The configuration of the information processing apparatus 100 according to the first embodiment will be described below. FIG. 3 is a diagram of a configuration of the information processing apparatus 100 according to the first embodiment. As illustrated in FIG. 3, the information processing apparatus 100 includes an interface (I/F) 110 and a control unit 120.

The I/F 110 transmits and receives various types of information to and from the network 20. For example, the I/F 110 receives a packet of bit stream data delivered from the delivery server 10 via the network 20.

The control unit 120 controls the whole information processing apparatus 100, and includes a decoding unit 121, an information acquiring unit 122, a quality-index-value calculating unit 123, an error region identifying unit 124, a pixel difference calculating unit 125, an error-diffusion-region estimating unit 126, and a quality-index-value correcting unit 127.

The decoding unit 121 decodes, when receiving bit stream data via the I/F 110, the bit stream data for each frame. The decoding unit 121 detects a region in which packet loss or a bit error occurs in a frame in addition to the decoding process. Specifically, the decoding unit 121 detects, from the region corresponding to the frame to be decoded, a region other than a region corresponding to a packet input via the I/F 110 as a region that is missing due to packet loss. The decoding unit 121 also detects a region in which a bit error occurs by performing parity check or the like.

According to the first embodiment, the decoding unit 121 performs the process of detecting packet loss or a bit error. However, a processing unit other than the decoding unit 121 may perform the detection process. For example, the information processing apparatus 100 may include an error detecting unit as a predetermined processing unit for detecting occurrence of packet loss or a bit error.

The information acquiring unit 122 acquires various types of information from the bit stream data received via the I/F 110 and the frame decoded by the decoding unit 121. Specifically, the information acquiring unit 122 acquires time information T, a block division size B, reference information R, such as motion vector information or a coding type, or information indicating types of video data (e.g., information indicating a natural image, an animation, or the like).

The time information T acquired by the information acquiring unit 122 is used for identifying a frame in video data. In the following, a pixel in a frame identified by the time information T among frames decoded by the decoding unit 121 is represented by a pixel (x, y, T). Here, “x” and “y” in the pixel (x, y, T) indicate a position on the x-coordinate and a position on the y-coordinate, respectively, when the frame is represented by the xy-coordinates. For example, a frame (300, 200, T) indicates a pixel of which x-coordinate and y-coordinate are (300, 200) from among pixels in the frame identified by the time information T.

The block division size B is used for, for example, calculating the quality index value S′. The reference information R, such as the motion vector information or the coding type, is used for estimating an error diffusion region. The type of video data is used for calculating the image difference level N.

The quality-index-value calculating unit 123 calculates the quality index value S′ of the frame decoded by the decoding unit 121. Specifically, the quality-index-value calculating unit 123 calculates, as the quality index value S′, the degree of block distortion or a cumulative value of edges of the frame in the same manner as the conventional NR method. The quality-index-value calculating unit 123 calculates the cumulative value of edges by using an edge detection filter such as a Sobel filter or a Prewitt filter.

The error region identifying unit 124 identifies an error region in the frame decoded by the decoding unit 121. Specifically, the error region identifying unit 124 identifies, as the error region, a region in which occurrence of packet loss is detected or in which occurrence of a bit error is detected by the decoding unit 121.

The error region identifying unit 124 defines information indicating whether a pixel is in the error region (hereinafter, referred to as “error region information”) for each pixel. In this specification, the error region information of “0” indicates that a pixel is not in the error region, and the error region information of “1” indicates that a pixel is in the error region. For example, when a pixel (0, 0, T) is not a pixel in the error region, the error region identifying unit 124 defines the error region information for the pixel (0, 0, T) as “0”. For example, when a pixel (1, 0, T) is a pixel in the error region, the error region identifying unit 124 defines the error region information for the pixel (1, 0, T) as “1”.

The pixel difference calculating unit 125 calculates the image difference level N in the error region identified by the error region identifying unit 124. Specifically, the pixel difference calculating unit 125 calculates values of a Y component, a U component, and a V component of each pixel for which “1 (with an error)” is defined as the error region information, and calculates the image feature C (the average of the Y components, the average of the U components, and the average of the V components) in the error region. Subsequently, the pixel difference calculating unit 125 calculates the shortest distance between the image feature threshold and the calculated image feature C in the color space. The information processing apparatus 100 then calculates the image difference level N by dividing the calculated shortest distance by a predetermined representative value.

The pixel difference calculating unit 125 changes the image feature threshold used for calculating the image difference level N, based on the information indicating the type of the video data, which is acquired by the information acquiring unit 122.

The pixel difference calculating unit 125 may calculate the averages of R (red) components, G (green) components, and B (blue) components of respective pixels in the error region. In this case, the pixel difference calculating unit 125 calculates the image difference level N based on the shortest distance between the image feature threshold and the calculated averages in the RGB color space.

When the frame to be processed is a frame that has been subjected to inter-frame prediction, such as the P frame or the B frame, the error-diffusion-region estimating unit 126 estimates an error diffusion region based on the motion vector information R acquired by the information acquiring unit 122. Specifically, the error-diffusion-region estimating unit 126 estimates, as the error diffusion region, a region that refers to an error region of a reference source frame and in which each average of the Y components, the U components, and the V components is close to the image feature C calculated by the pixel difference calculating unit 125.

The error-diffusion-region estimating unit 126 then defines information indicating whether a pixel is in the error diffusion region (hereinafter, referred to as “error diffusion region information”) for each pixel. In this specification, the error diffusion region information of “0” indicates that a pixel is not in the error diffusion region, and the error diffusion region information of “1” indicates that a pixel is in the error diffusion region. For example, when a pixel (0, 0, T) is not a pixel in the error diffusion region, the error-diffusion-region estimating unit 126 defines the error diffusion region information for the pixel (0, 0, T) as “0”. For example, when a pixel (1, 0, T) is a pixel in the error diffusion region, the error-diffusion-region estimating unit 126 defines the error diffusion region information for the pixel (1, 0, T) as “1”.

The quality-index-value correcting unit 127 calculates the quality index value S by correcting the quality index value S′ calculated by the quality-index-value calculating unit 123. Specifically, when a frame to be processed is not a frame that has been subjected to inter-frame prediction, the quality-index-value correcting unit 127 counts pixels for which the error region information indicates “1”, and calculates the size of the error region. Subsequently, the quality-index-value correcting unit 127 calculates the error region ratio Q by dividing the size of the error region by the size of the frame.

On the other hand, when the frame to be processed is a frame that has been subjected to inter-frame prediction, the quality-index-value correcting unit 127 calculates the size of the error region and counts pixels for which the error diffusion region information indicates “1” to thereby calculate the size of the error diffusion region. Subsequently, the quality-index-value correcting unit 127 calculates the error region ratio Q by dividing the sum of the size of the error region and the size of the error diffusion region by the size of the frame.

The quality-index-value correcting unit 127 then calculates the quality index value S based on the calculated error region ratio Q, the quality index value S′ calculated by the quality-index-value calculating unit 123, and the image difference level N calculated by the pixel difference calculating unit 125. Specifically, the quality-index-value correcting unit 127 calculates the quality index value S according to the above Equation (1).

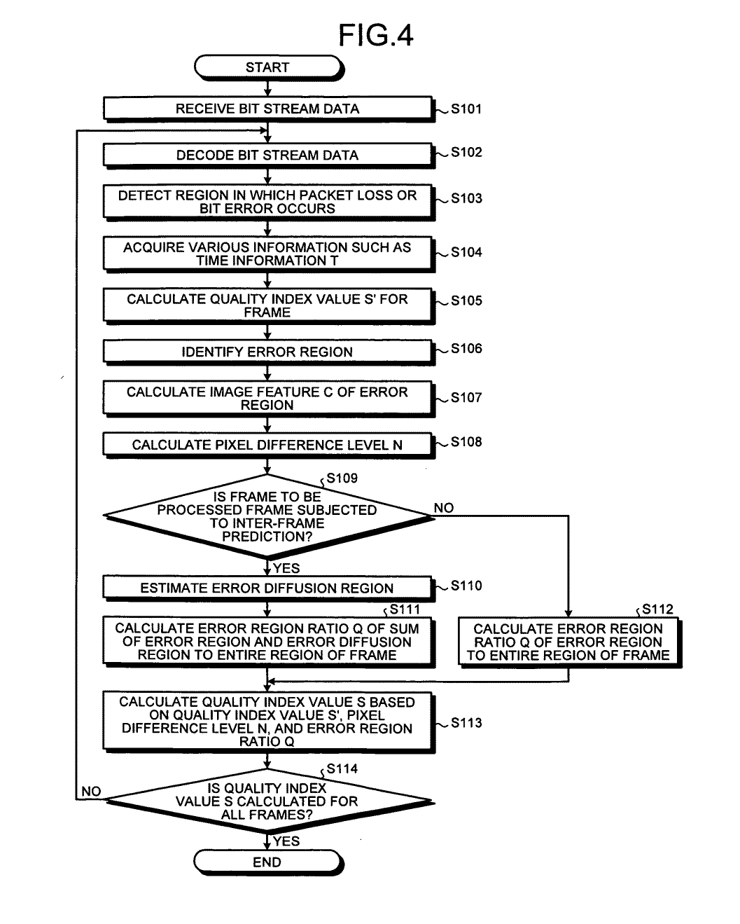

A procedure of a quality-index-value calculation process performed by the information processing apparatus 100 according to the first embodiment will be described below. FIG. 4 is a flowchart illustrating the procedure of the quality-index-value calculation process performed by the information processing apparatus 100 according to the first embodiment. As illustrated in FIG. 4, the information processing apparatus 100 receives bit stream data via the I/F 110 (Step S101).

The decoding unit 121 decodes the received bit stream data for each frame (Step S102). At this time, the decoding unit 121 detects a region, in which packet loss or a bit error occurs, in the frame (Step S103).

The information acquiring unit 122 acquires various types of information, such as the time information T, the block division size B, or the reference information R, from the received bit stream data and the frame decoded by the decoding unit 121 (Step S104).

The quality-index-value calculating unit 123 calculates the quality index value S′ of the frame decoded by the decoding unit 121 (Step S105). The error region identifying unit 124 identifies an error region based on the region in which the occurrence of the packet loss or the bit error is detected by the decoding unit 121 (Step S106).

The pixel difference calculating unit 125 calculates the image feature C for each pixel for which the error region information of “1 (with an error)” is defined (Step S107). The pixel difference calculating unit 125 then calculates the shortest distance between the image feature threshold and the image feature C in the color space. The pixel difference calculating unit 125 calculates the image difference level N by dividing the calculated shortest distance by a predetermined representative value (Step S108).

When the frame to be processed is a frame that has been subjected to inter-frame prediction (YES at Step S109), the error-diffusion-region estimating unit 126 estimates an error diffusion region based on the motion vector information R acquired by the information acquiring unit 122 (Step S110). The quality-index-value correcting unit 127 then calculates the error region ratio Q as a ratio of a sum of the error region and the error diffusion region to the entire region of the frame (Step S111).

On the other hand, when the frame to be processed is not a frame that has been subjected to inter-frame prediction (NO at Step S109), the quality-index-value correcting unit 127 calculates the error region ratio Q as a ratio of the error region to the entire region of the frame (Step S112).

The quality-index-value correcting unit 127 calculates the quality index value S based on the quality index value S′ calculated by the quality-index-value calculating unit 123, the image difference level N calculated by the pixel difference calculating unit 125, and the error region ratio Q calculated at Step S111 or Step S112 (Step S113). When the information processing apparatus 100 completes calculation of the quality index values S for all of the frames in the video data (YES at Step S114), the process ends. On the other hand, when the information processing apparatus 100 does not complete calculation of the quality index values S for all of the frames in the video data (NO at Step S114), the processes at Step S102 to S114 are repeated.

As described above, the information processing apparatus 100 according to the first embodiment calculates the quality index value S′ that indicates objective quality by taking into account the degree of block distortion or edge sharpness. The information processing apparatus 100 then calculates the quality index value S by correcting the quality index value S′ based on the error region ratio Q and the image difference level N. Therefore, the information processing apparatus 100 can calculate the quality index value S indicating the quality of video data that is approximately the same as the quality determined by a person.

In the first embodiment, an example is illustrated in which the error region identifying unit 124 identifies a region in which packet loss or a bit error occurs as the error region. However, the information processing apparatus 100 may identify the error region by calculating the image feature C for each pixel in the frame. Specifically, the information processing apparatus 100 may identify, as the error region, a pixel for which the calculated image feature C is not in the range of the image feature threshold. The information processing apparatus 100 with this feature can be applied to calculation of the quality index value S of video data that has been received without through the network 20.

### [b] Second Embodiment

It is possible for a predetermined apparatus to analyze the quality of video data based on the quality index value S calculated by each information processing apparatus. In a second embodiment, a video delivery system is explained that includes an information processing apparatus for calculating the quality index value S and a quality management apparatus that analyzes the quality index value S.

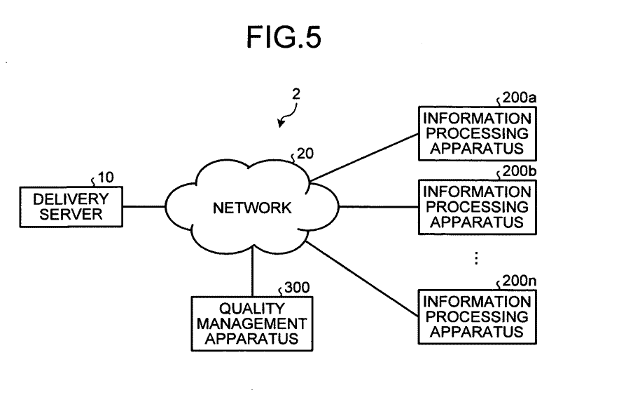

A video delivery system 2 according to the second embodiment will be described. FIG. 5 is a diagram illustrating the video delivery system 2 according to the second embodiment. As illustrated in FIG. 5, the video delivery system 2 includes the delivery server 10 and information processing apparatuses 200a to 200n that receive video data via the network 20. In the following description, the information processing apparatuses 200a to 200n are collectively referred to as the information processing apparatus 200 when they need not be identified.

The information processing apparatus 200 calculates the quality index value S of bit stream data received from the delivery server 10 for each frame, similarly to the first embodiment. The information processing apparatus 200 transmits various types of information including the calculated quality index value S (hereinafter, referred to as “quality related information”) to a quality management apparatus 300.

The quality management apparatus 300 receives the quality related information from the information processing apparatus 200 and analyzes the quality of video data held by the information processing apparatus 200 based on the received quality related information. Specifically, when receiving pieces of quality related information on identical video data from a plurality of information processing apparatuses 200, the quality management apparatus 300 compares the pieces of quality related information with each other to determine whether the video data held by the information processing apparatus 200 has the quality equal to or greater than a predetermined reference value.

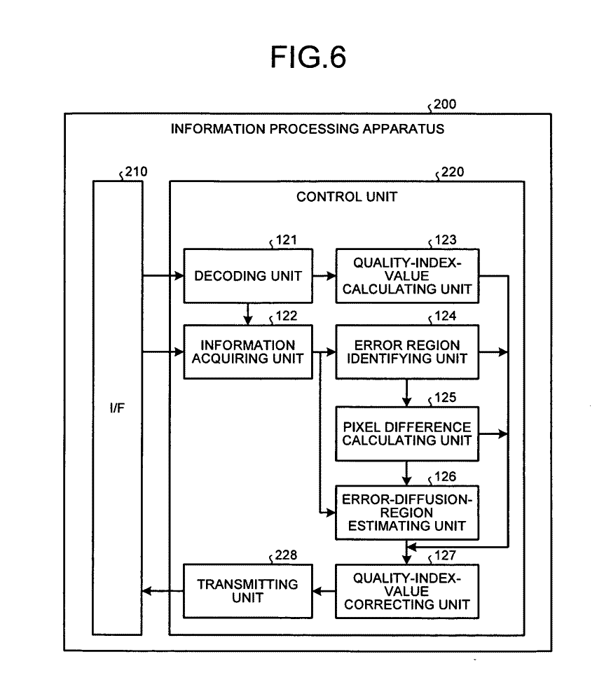

The configuration of the information processing apparatus 200 illustrated in FIG. 5 will be described below. FIG. 6 is a diagram of the configuration of the information processing apparatus 200 illustrated in FIG. 5. Components having identical functions as those of the components illustrated in FIG. 3 are denoted by identical reference symbols, and detailed explanation thereof is not repeated. As illustrated in FIG. 6, the information processing apparatus 200 includes an I/F 210 and a control unit 220.

The control unit 220 additionally includes a transmitting unit 228, which is different from the control unit 120 illustrated in FIG. 3. The transmitting unit 228 transmits the quality related information including the quality index value S calculated by the quality-index-value correcting unit 127 to the quality management apparatus 300 via the I/F 210. Specifically, the transmitting unit 228 transmits the quality related information including the quality index value S, the time information T for identifying a frame, the error region information, the error diffusion region information, the error region ratio Q, the image difference level N, and the like, for each frame.

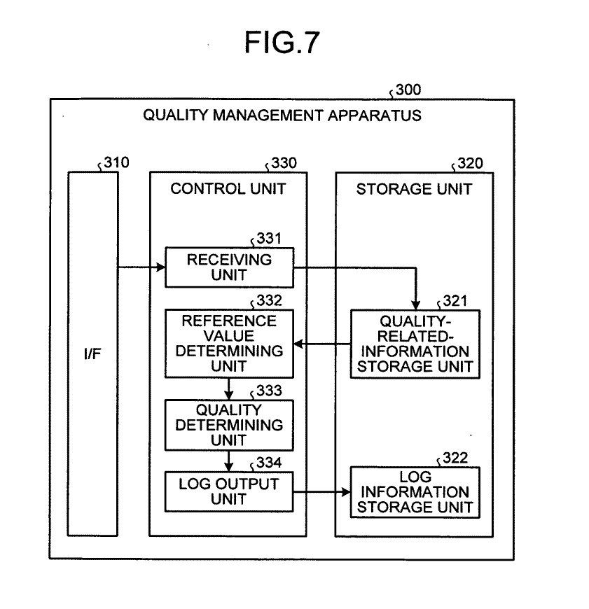

The configuration of the quality management apparatus 300 illustrated in FIG. 5 will be described below. FIG. 7 is a diagram of the configuration of the quality management apparatus 300 illustrated in FIG. 5. As illustrated in FIG. 7, the quality management apparatus 300 includes an I/F 310, a storage unit 320, and a control unit 330. The I/F 310 transmits and receives various types of information to and from the network 20. For example, the I/F 310 receives the quality related information from the information processing apparatus 200 via the network 20.

The storage unit 320 is a storage device for storing various types of information, and includes a quality-related-information storage unit 321 and a log information storage unit 322. The quality-related-information storage unit 321 stores therein the quality related information received by a receiving unit 331, which will be described later. The log information storage unit 322 stores therein log information, and is, for example, text file or a table.

The control unit 330 controls the whole quality management apparatus 300, and includes the receiving unit 331, a reference value determining unit 332, a quality determining unit 333, and a log output unit 334. The receiving unit 331 receives various types of information via the I/F 310. When receiving the quality related information, the receiving unit 331 stores the received quality information in the quality-related-information storage unit 321.

The reference value determining unit 332 determines, for each frame, a reference value of a quality index value (hereinafter, referred to as a “quality index reference value”) based on the quality related information stored in the quality-related-information storage unit 321. Specifically, the reference value determining unit 332 acquires pieces of quality related information, which are on identical video data and have identical time information T, from the quality-related-information storage unit 321. The reference value determining unit 332 then acquires pieces of quality related information, which indicates that an error has occurred due to packet loss or the like, out of the acquired pieces of quality related information. At this time, the reference value determining unit 332 determines occurrence of an error based on any one of the error region information, the error diffusion region information, and the error region ratio Q. For example, when the error region information is “0” for all of the pieces of the information, because this indicates that the error region is not present, the reference value determining unit 332 determines that an error has not occurred.

The reference value determining unit 332 then compares all of the quality index values S contained in all of the acquired pieces of the quality related information. As a result of comparison, when there is no difference between the quality index values S, the reference value determining unit 332 determines to apply the quality index values S contained in the acquired pieces of the quality related information to be a quality index reference value Ss. On the other hand, when there is a difference between the quality index values S, the reference value determining unit 332 determines that the greatest number of quality index values S to be the quality index reference value Ss. For example, when all of the quality index values S contained in the acquired pieces of the quality related information are “100, 100, 100, 105, 110”, because the number of “100” is the greatest, the reference value determining unit 332 determines “100” to be the quality index reference value Ss. When there is a difference between the acquired pieces of the quality index values S, the reference value determining unit 332 may determine an average of the acquired quality index values S as the quality index reference value Ss.

The quality determining unit 333 determines whether each frame has the quality equal to or lower than a predetermined standard. Specifically, the quality determining unit 333 calculates a value (hereinafter, referred to as a “quality index allowable value”) Sth by dividing the quality index reference value Ss determined by the reference value determining unit 332 by a predetermined threshold. The quality determining unit 333 then acquires the quality related information for which the quality index value S is equal to or greater than the quality index allowable value Sth from the quality-related-information storage unit 321. The quality determining unit 333 determines a frame indicated by the acquired quality related information as the frame of which quality is equal to or lower than a predetermined standard.

For example, when the quality index reference value Ss is “100” and a threshold is “0.8”, the quality determining unit 333 calculates, as the quality index allowable value Sth, a value “125” by dividing the quality index reference value Ss “100” by the threshold “0.8”. The quality determining unit 333 then acquires the quality related information of which quality index value S is equal to or greater than the quality index allowable value Sth of “125” from the quality-related-information storage unit 321.

The log output unit 334 outputs information related to the frame identified by the quality determining unit 333 to the log information storage unit 322. Specifically, the log output unit 334 outputs information for identifying the information processing apparatus 200 that has transmitted the frame identified by the quality determining unit 333 or the quality related information of the frame, to the log information storage unit 322 in a predetermined format.

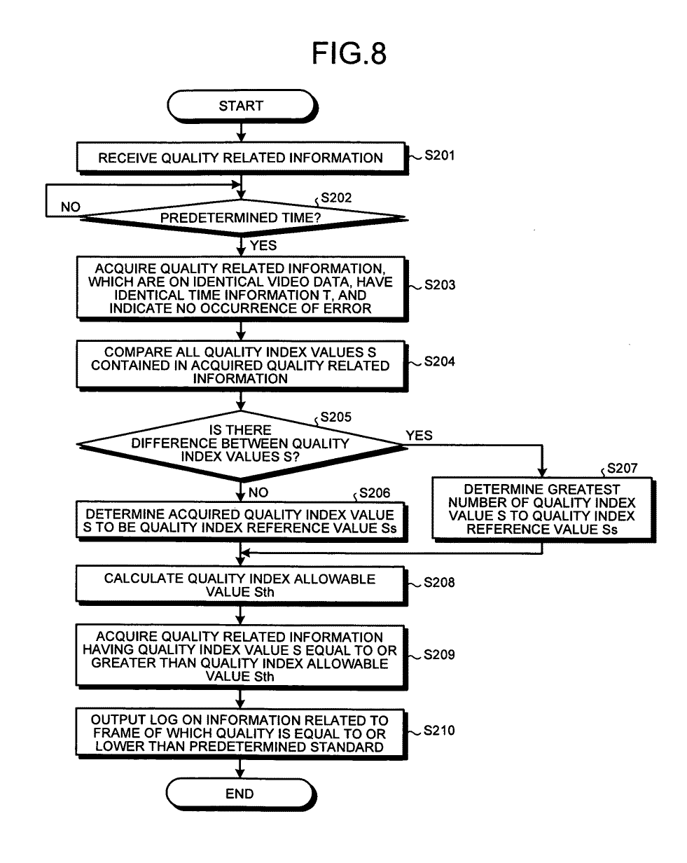

A procedure of a quality determination process performed by the quality management apparatus 300 illustrated in FIG. 5 will be described below. FIG. 8 is a flowchart illustrating the procedure of the quality determination process performed by the quality management apparatus 300 illustrated in FIG. 5. As illustrated in FIG. 8, the receiving unit 331 of the quality management apparatus 300 receives the quality related information from the information processing apparatus 200 (Step S201), and stores the received quality related information in the quality-related-information storage unit 321.

At a predetermined time (YES at Step S202), the reference value determining unit 332 acquires pieces of quality related information, which are on identical video data, have identical time information T, and indicate no occurrence of an error, from the quality-related-information storage unit 321 (Step S203). The “predetermined time” corresponds to time of detection of acquisition of the pieces of the quality related information on frames constituting identical video data from a plurality of information processing apparatuses 200.

The reference value determining unit 332 compares all of the quality index values S contained in the acquired pieces of the quality related information (Step S204). As a result of comparison, when there is no difference between the quality index values S (NO at Step S205), the reference value determining unit 332 determines the acquired quality index values S to be the quality index reference value Ss (Step S206). On the other hand, when there is a difference between the acquired quality index values S (YES at Step S205), the reference value determining unit 332 determines the quality index value S, the number thereof is the greatest, to the quality index reference value Ss (Step S207).

The quality index reference value Ss determined by the reference value determining unit 332 is divided by a predetermined threshold, so that the quality index allowable value Sth is calculated (Step S208). The quality determining unit 333 acquires the quality related information of which quality index value S is equal to or greater than the quality index allowable value Sth from the quality-related-information storage unit 321 (Step S209). The quality determining unit 333 determines the frame indicated by the acquired quality related information to be a frame of which quality is equal to or lower than a predetermined standard.

The log output unit 334 outputs, to the log information storage unit 322, information on the frame identified by the quality determining unit 333 or information for identifying the information processing apparatus 200 that has transmitted the frame (Step S210).

As described above, in the video delivery system 2 according to the second embodiment, the information processing apparatus 200 calculates the quality index value S and transmits the quality related information including the calculated quality index value S to the quality management apparatus 300. The quality management apparatus 300 receives the quality related information from a plurality of information processing apparatuses 200, compares the received pieces of the quality related information, and determines whether each frame constituting the video data has the quality equal to or greater than a reference value. Accordingly, the video delivery system 2 can automatically determine whether the video data held by the information processing apparatus 200 has the quality equal to or greater than a predetermined reference value. As a result, with use of the video delivery system 2, a user can confirm the quality of video data held by the plurality of information processing apparatuses 200 only by checking the result of the quality determination process (information stored in the log information storage unit 322) performed by the quality management apparatus 300.

In the second embodiment described above, an example is described in which the quality management apparatus 300 performs the quality determination process for each frame. However, the quality management apparatus 300 may segment the video data by a plurality of frames and determine whether an average of the quality index values S of a plurality of frames is equal to or smaller than a predetermined standard. For example, the quality management apparatus 300 may segment the video data every time an I frame appears, and perform the quality determination process for each segment. For example, the quality management apparatus 300 may analyze the quality assuming that one piece of video data corresponds to one segment.

In the first and second embodiments, an example is described in which when a frame to be processed is a frame that has been subjected to inter-frame prediction, the error-diffusion-region estimating unit 126 estimates the error diffusion region. However, the error-diffusion-region estimating unit 126 may estimate the error diffusion region even when a frame to be processed is a frame that has been subjected to intra prediction. In this case, the error-diffusion-region estimating unit 126 estimates, as the error diffusion region, a region that refers to the error region in the frame to be processed and in which an average of the Y components, an average of the U components, and an average of the V components are close to the image feature C calculated by the pixel difference calculating unit 125.

In the first and second embodiments, an example is described in which the quality-index-value calculating unit 123 calculates the quality index value S′ by using a method similar to the conventional NR method. However, the quality-index-value calculating unit 123 may calculate the quality index value S′ by using a method similar to the conventional RR method. In this case, the delivery server 10 transmits, to the information processing apparatus 100 or the information processing apparatus 200, feature data for each frame in the video data to be delivered. The information processing apparatus 100 or the information processing apparatus 200 calculates the quality index value S′ based on the feature data decoded by the decoding unit 121 and the feature data received from the delivery server 10.

The configurations of the information processing apparatuses 100 and 200 illustrated in FIG. 3 and FIG. 6, respectively, may be modified in various forms without departing from the scope of the present invention. For example, the same functions as those of the information processing apparatus 100 or the information processing apparatus 200 may be realized by implementing the functions of the control unit 120 or the control unit 220 by software and causing a computer to execute the functions. An example of a computer that executes a quality-index-value calculation program 1071 for implementing the functions of the control unit 120 by software will be described below.

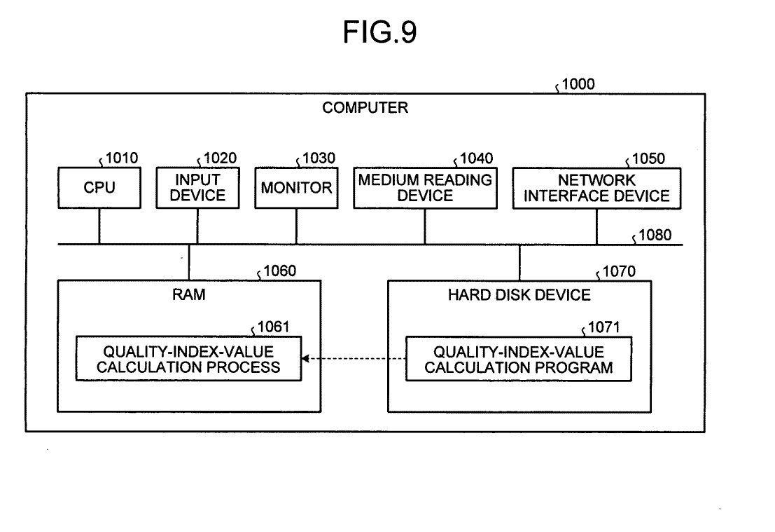

FIG. 9 is a diagram illustrating a computer 1000 that executes the quality-index-value calculation program 1071. The computer 1000 includes a CPU (Central Processing Unit) 1010 that executes various types of arithmetic processing, an input device 1020 that receives input of data from a user, a monitor 1030 that displays various types of information, a medium reading device 1040 that reads computer programs or the like from a recording medium, a RAM (Random Access Memory) 1060 that temporarily stores therein various types of information, and a hard disk device 1070, which are connected to one another via a bus 1080.

The hard disk device 1070 stores therein the quality-index-value calculation program 1071 having the same functions as those of the control unit 120 illustrated in FIG. 3. The CPU 1010 reads the quality-index-value calculation program 1071 from the hard disk device 1070 and loads the quality-index-value calculation program 1071 onto the RAM 1060, so that the quality-index-value calculation program 1071 functions as a quality-index-value calculation process 1061. The quality-index-value calculation process 1061 executes various types of data processing.

The quality-index-value calculation program 1071 is not necessarily stored in the hard disk device 1070. It is possible to cause the information processing apparatus 100 to read and execute the quality-index-value calculation program 1071 stored in a storage medium such as a CD-ROM. It is also possible to store the quality-index-value calculation program 1071 in a computer (or a server) connected to the computer 1000 via a public line, the Internet, a LAN (Local Area Network) or a WAN (Wide Area Network), and cause the computer 1000 to read and executes the quality-index-value calculation program 1071.

The configuration of the quality management apparatus 300 illustrated in FIG. 7 may be modified in various forms without departing from the scope of the present invention. For example, it is possible to implement the functions of the control unit 330 of the quality management apparatus 300 by software and cause a computer to execute the software to realize the same functions as those of the quality management apparatus 300. An example of a computer that executes a quality determination program 2071 for implementing the functions of the control unit 330 by software will be described below.

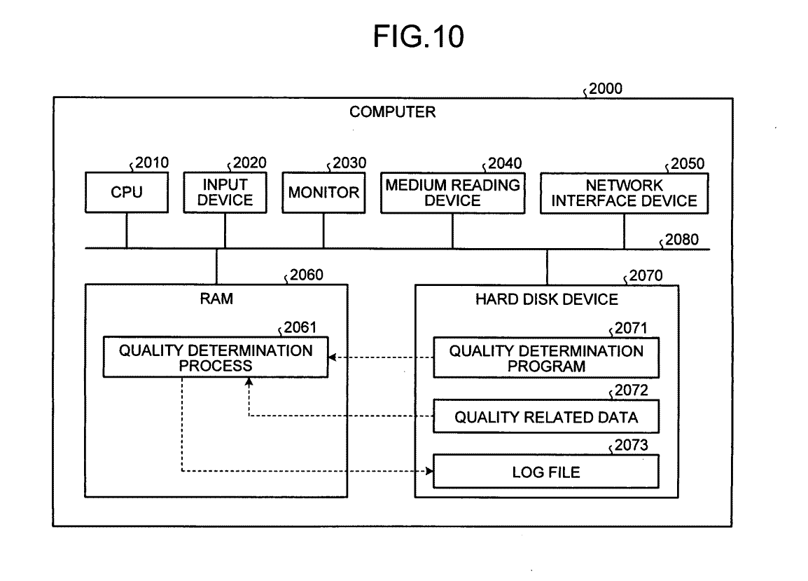

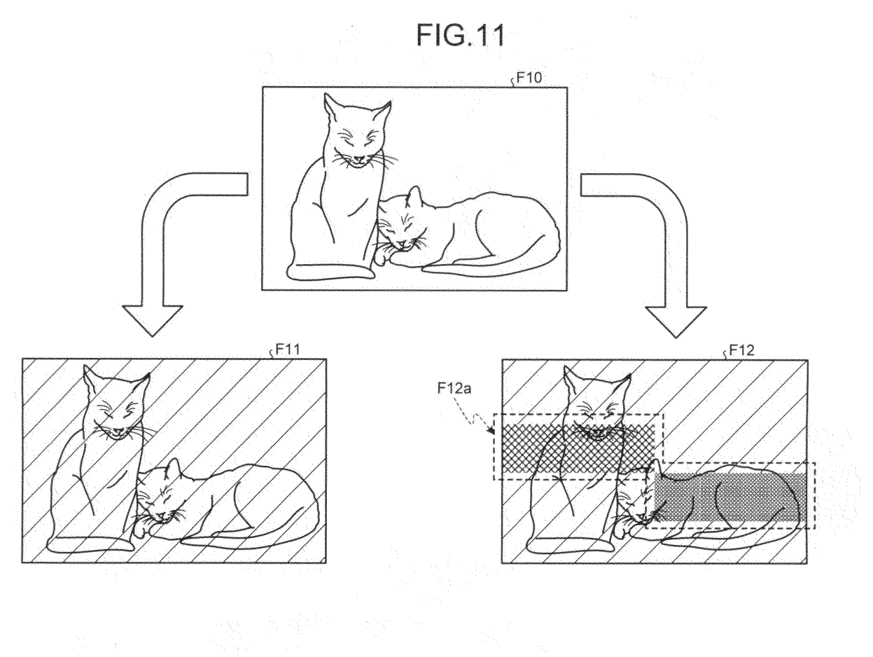

FIG. 10 is a diagram illustrating a computer 2000 that executes the quality determination program 2071. The computer 2000 includes a CPU 2010 that executes various types of arithmetic processing, an input device 2020 that receives input of data from a user, a monitor 2030 that displays various types of information, a medium reading device 2040 that reads computer programs from a recording medium, a network interface device 2050 that transmits and receives data to and from other computers via a network, a RAM 2060 that temporarily stores therein various types of information, and a hard disk device 2070, which are connected to one another via a bus 2080.

The hard disk device 2070 stores therein the quality determination program 2071 having the same functions as those of the control unit 330 illustrated in FIG. 7, quality related data 2072 corresponding to various types of data stored in the quality-related-information storage unit 321 illustrated in FIG. 7, and a log file 2073 corresponding to the log information storage unit 322 illustrated in FIG. 7. It is possible to appropriately distribute the quality related data 2072 or the log file 2073 so as to be stored in other computers connected to the computer 2000 via a network.

The CPU 2010 reads the quality determination program 2071 from the hard disk device 2070 and loads the quality determination program 2071 onto the RAM 2060, so that the quality determination program 2071 functions as a quality determination process 2061. The quality determination process 2061 appropriately loads information or the like read from the quality related data 2072 onto a region allocated to the process on the RAM 2060, and executes various types of data processing based on the loaded data or the like. The quality determination process 2061 output predetermined information to the log file 2073.

According to a quality-index-value calculation method disclosed herein, it is possible to calculate a quality index value indicating the quality of video data that is approximately the same as the quality determined by a person.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A quality-index-value calculation method implemented by an information processing apparatus that calculates quality of video data, the quality-index-value calculation method comprising:
receiving video data that is divided into packets;
decoding the video data for each frame when the packets are received at the receiving;
detecting whether any packet is lost based on the packets received at the receiving, and detecting whether a bit error occurs in the packets received at the receiving;
identifying, as an error region, a region corresponding to a packet that is detected as being lost at the detecting and a region in which the bit error is detected at the detecting from an entire region of each frame decoded at the decoding;
calculating a ratio of the error region identified at the identifying to the entire region of each frame, as a quality index value indicating the quality of the frame; and
calculating a pixel difference between an average of pixel values in the error region identified at the identifying and a predetermined threshold for each frame.

2. The quality-index-value calculation method according to claim 1, further comprising:
identifying, when a frame that has been coded by inter-frame prediction or intra prediction is decoded at the decoding, an error diffusion region that is a region that refers to the error region in the frame, wherein
the calculating includes calculating a ratio of a sum of the error region identified at the identifying the error region and the error diffusion region identified at the identifying the error diffusion region to the entire region of each frame.

3. The quality-index-value calculation method according to claim 2, further comprising:
calculating, as a parameter, any one of a degree of block distortion, a cumulative value of edges, and feature data of each frame constituting the video data;
calculating a quality index value for each frame based on the parameter; and
correcting the quality index value calculated at the calculating so that the quality index value indicates lower quality as the ratio of the error region calculated at the calculating increases.

4. The quality-index-value calculation method according to claim 3, wherein
the correcting includes correcting the quality index value so that the quality index value indicates lower quality as the pixel difference calculated at the calculating increases.

5. A quality-index-value calculation method implemented by an information processing apparatus that calculates quality of video data, the quality-index-value calculation method comprising:
identifying an error region that is a region corresponding to a pixel value that is out of a predetermined threshold range, for each frame constituting the video data;
calculating a ratio of the error region identified at the identifying to an entire region of the frame, as a quality index value indicating the quality of the frame; and
calculating a pixel difference between an average of pixel values in the error region identified at the identifying and a predetermined threshold that is the closest to the average of pixel values among the predetermined threshold range for each frame.

6. The quality-index-value calculation method according to claim 5, further comprising:
calculating, as a parameter, any one of a degree of block distortion, a cumulative value of edges, and feature data of each frame constituting the video data;
calculating a quality index value for each frame based on the parameter;
correcting the quality index value calculated at the calculating so that the quality index value indicates lower quality as the ratio of the error region calculated at the calculating increases; and
correcting the quality index value calculated at the calculating so that the quality index value indicates lower quality as the pixel difference calculated at the calculating increases.

7. An information processing apparatus comprising:
a receiving unit that receives video data that is divided into packets;
a decoding unit that decodes the video data for each frame when the packets are received by the receiving unit;
an error detecting unit that detects whether any packet is lost based on the packets received by the receiving unit;
an error region identifying unit that identifies an error region corresponding to the packet that is detected as being lost by the error detecting unit from an entire region of each frame decoded by the decoding unit;
an error region ratio calculating unit that calculates a ratio of the error region identified by the error region identifying unit to the entire region of each frame, as a quality index value indicating the quality of the frame; and
a pixel difference calculating unit that calculates a pixel difference between an average of pixel values in the error region identified by the error region identifying unit and a predetermined threshold for each frame.

8. The information processing apparatus according to claim 7, further comprising:
an error-diffusion-region identifying unit that identifies, when a frame that has been coded by inter-frame prediction or intra prediction is decoded at the decoding, an error diffusion region that is a region that refers to the error region in the frame, wherein
the error region ratio calculating unit that calculates a ratio of a sum of the error region identified by the error region identifying unit and the error diffusion region identified by the error-diffusion-region identifying unit to the entire region of each frame.

9. The information processing apparatus according to claim 7, further comprising:
a quality-index-value calculating unit that calculates, as a parameter, any one of a degree of block distortion, a cumulative value of edges, and feature data of each frame constituting the video data, and calculates a quality index value for each frame based on the parameter; and
a quality-index-value correcting unit that corrects the quality index value calculated by the quality-index-value calculating unit so that the quality index value indicates lower quality as the ratio of the error region calculated by the error region ratio calculating unit increases.

10. A video delivery system comprising:
an information processing apparatus that receives video data divided into packets; and
a quality management apparatus that manages quality of the video data, wherein
the information processing apparatus includes:
a decoding unit that decodes the video data for each frame when receiving the packets;
an error detecting unit that detects whether any packet is lost based on the received packets;
an error region identifying unit that identifies an error region corresponding to a packet that is detected as being lost by the error detecting unit from an entire region of the frame decoded by the decoding unit; and
an error region ratio calculating unit that calculates a ratio of the error region identified by the error region identifying unit to the entire region of the frame, for each frame, as a quality index value indicating the quality of the frame, and
the quality management apparatus includes:
a receiving unit that receives a combination of a quality index value of a frame constituting the video data and error information indicating whether packet loss or a bit error occurs, from the information processing apparatus;
a reference value determining unit that determines, as a reference value of the quality index value, a quality index value for which the error information indicates that the packet loss and the bit error have not occurred out of a plurality of quality index values received by the receiving unit; and
a quality determining unit that determines whether a difference between the quality index value and the reference value determined by the reference value determining unit is greater than a predetermined threshold for each quality index value received by the receiving unit.

11. A non-transitory computer readable storage medium storing therein a program for calculating quality-index-value calculating a computer to execute a process comprising:
receiving video data that is divided into packets;
decoding the video data for each frame when the packets are received at the receiving;
detecting whether any packet is lost based on the packets received at the receiving, and detecting whether a bit error occurs in the packets received at the receiving;
identifying, as an error region, a region corresponding to a packet that is detected as being lost at the detecting and a region in which the bit error is detected at the detecting from an entire region of each frame decoded at the decoding;
calculating a ratio of the error region identified at the identifying to the entire region of each frame, as a quality index value indicating the quality of the frame; and
calculating a pixel difference between an average of pixel values in the error region identified at the identifying and a predetermined threshold for each frame.

12. An information processing apparatus comprising:
a processor; and
a memory, wherein the processor executes:
receiving video data that is divided into packets;
decoding the video data for each frame when the packets are received at the receiving;
detecting whether any packet is lost based on the packets received at the receiving;
identifying an error region corresponding to the packet that is detected as being lost at the detecting from an entire region of each frame decoded at the decoding;
calculating a ratio of the error region identified at the identifying to the entire region of each frame, as a quality index value indicating the quality of the frame; and
calculating a pixel difference between an average of pixel values in the error region identified at the identifying and a predetermined threshold for each frame.
